(19) United States
(12) Patent Application Publication
(10) Pub. No.: US 2025/0286873 A1
(43) Pub. Date: Sep. 11, 2025

(54) METHODS AND SYSTEMS FOR REMOTE AUTHENTICATION TO ACCESS ENTERPRISE RESOURCES

(71) Applicant: Nelson A. CICCHITTO, San Ramon, CA (US)

(72) Inventor: Nelson A. CICCHITTO, San Ramon, CA (US)

(21) Appl. No.: 19/067,627

(22) Filed: Feb. 28, 2025

Related U.S. Application Data
(60) Provisional application No. 63/562,678, filed on Mar. 7, 2024.

(51) Int. Cl. H04L 9/40

(52) U.S. Cl. CPC H04L 63/08; H04L 63/10; H04L 63/1433

(57) ABSTRACT

Methods and systems for remote authentication to access enterprise resources are disclosed. A method of remotely authenticating access to a resource can include: (i) establishing a communicative connection between a user and an authenticator, where the user requests access to the resource of the enterprise, (ii) obtaining, by the authenticator, user information associated with the user, (iii) selecting, by the authenticator, a multi-factor authentication (MFA) platform based at least in part on the user information, (iv) initiating, by the authenticator, operation of the selected MFA platform, (v) verifying, by the authenticator, an identity of the user based at least in part on input provided by the user, where the input is associated with operation of the selected MFA platform, and (vi) providing permission to access the resource of the enterprise in response to verification of the identity of the user.

### CROSS-REFERENCE TO RELATED APPLICATION(S)

This application claims priority to U.S. Provisional Application No. 63/562,678, titled “METHOD AND SYSTEM FOR HUMAN ASSISTED AUTHENTICATION,” and filed Mar. 7, 2024, which is incorporated by reference herein in its entirety.

### TECHNICAL FIELD

This invention relates generally to the field of remote authentication to access enterprise resources. More specifically, this invention relates to remotely-assisted authentication to access enterprise resources using Multi-factor Authentication (MFA).

### BACKGROUND

Typically, when an individual calls a service provider (e.g., a bank, healthcare provider, television streaming service, etc.) to get information, such as a balance on their account, query reward points, schedule a service appointment, etc., the service provider almost always uses a cumbersome process to confirm the identity of the individual. Often, a customer service representative will ask personal questions based on the data in their customer relationship management system, such as their zip code, mailing address, phone number, mother's maiden name, etc. Unfortunately, this approach can be insufficiently secure, and may permit bad actors who know a lot about an individual's personal life and identity to gain access to sensitive information about the individual and/or service provider.

### BRIEF DESCRIPTION OF THE DRAWINGS

FIG. 1 is a schematic diagram of an application container hosted system for remote authentication using a Multi-factor Authentication (MFA) of an enterprise, in accordance with embodiments of the disclosed technology.

FIG. 2 is a method of remotely authenticating access to enterprise resources, in accordance with embodiments of the disclosed technology.

FIGS. 3-19 are illustrations of a remote authentication interface and process for validating a user, in accordance with embodiments of the disclosed technology.

FIG. 20 is a system diagram illustrating an example of a computing environment in which the disclosed system operates, in accordance with embodiments of the disclosed technology.

FIG. 21 is a block diagram illustrating an example machine learning (ML) system, in accordance with embodiments of the disclosed technology.

FIG. 22 is a block diagram illustrating an example computer system, in accordance with embodiments of the disclosed technology.

### DETAILED DESCRIPTION

Methods and systems for remote authentication to access enterprise resources are disclosed. For example, a method of remotely authenticating access to a resource (e.g., a user password) of an enterprise can include: (i) establishing a communicative connection between a user and an authenticator (e.g., a person, a machine learning (ML)/artificial intelligence (Al) assistant, etc.), where the user requests access to the resource of the enterprise, (ii) obtaining, by the authenticator, user information associated with the user (e.g., an employee email registered with the enterprise), (iii) selecting, by the authenticator, a multi-factor authentication (MFA) platform based at least in part on the user information, (iv) initiating, by the authenticator, operation of the selected MFA platform, (v) verifying, by the authenticator, an identity of the user based at least in part on input provided by the user, where the input is associated with operation of the selected MFA platform, and (vi) providing permission to access the resource of the enterprise in response to verification of the identity of the user.

In typical and present consumer life, individuals have logged into their bank, healthcare provider, television streaming service, or for that matter any service provider using something you know (such as your account name, password, or answer to a secret question) and something you have (such as some form of Multi-factor Authentication (MFA)). This is common and individuals have come to accept the added layer of security that MFA brings to the authentication process.

Conversely, if one calls the service provider to get information such as a balance on their account, query reward points, schedule a service appointment, etc., the service provider almost always uses an entirely different and usually very cumbersome process to confirm their identity. Banks, credit card companies, and utilities already have weak security measures built in. It seems that any time one calls to inquire about service or their account a customer service representative (CSR) will ask personal questions based on the data in their customer relationship management (CRM) system, such as their zip code, mailing address, phone number, mother's maiden name, etc. This approach is not secure enough. Unfortunately, this process typically is tilted towards people who know a lot about your personal life and identity.

In fact, in many cases, not much information is needed to hack the bank account of an individual by getting past a human customer service representative. For example, a bad actor can often access sensitive information using only one or more of:
1. Name
2. Email
3. SSN
4. Driver's License Number
5. Credit Card or Bank Account Information

In some cases, an angry spouse, scorned loved one, former co-worker, etc. may have the personal information they need to pass the lack luster human assisted authentication (HAA) provided by the service provider or service desk personal. This approach has led to the wrong people getting access to bank records, human resources (HR), payroll, and benefits information. The same risks apply to other sensitive personal data such as health records, employment records, pay stubs, etc.

A famous example occurred in August 2019 when a NASA astronaut was accused of hacking an ex-wife's bank account from space.

There are occasions when one needs a secure form of remote authentication (e.g., remote HAA). For example, before the pandemic, various United States government agencies required workers to renew their personal identity verification card credentials regularly (e.g., HID PIV cards). This situation meant appearing at the security office for fingerprinting and other forms of authentication to reissue their government IDs.

During the pandemic these security offices were closed and government employees were sequestered at home. This situation meant visiting the security office to renew their IDs was out of the question. In such instances, a new form of identity verification was (and is) needed to maintain security. Adding a modernized form of remote/remotely-assisted authentication to the process ensures proper authentication without compromising securing protocols.

It has been found that typically almost every enterprise has their own unique way to confirm their workforce, vendors, customers, students, doctors, nurses, etc., for when those entities call the service desk or customer service.

In a poll of hundreds of IT Security Directors and Service Desk Managers asking, “How does your organization confirm the identity of the person calling the service desk?”

The results were as follows:
17% had very secure methods of confirming end users calling the service desk.
   (examples included: requiring in person meetings for secure facilities, requiring something they have, plus something they know, launching a video chat and comparing that to photos of the workforce personnel.)
48% required some form of consistent authentication for remote workers when calling the service desk.
   (examples included: sharing employee number, managers name, date of hire, etc.)
35% did not have any formal process of confirming people calling the service desk.
   (examples included: no confirmation of identity or no formal method of confirming identity as people call the service desk.)

Embodiments of the disclosed technology address the following question: Why does confirming the identity of an entity have to be different if they call a service or help desk than it does if they interact with a computer or cloud service? The short answer is it does not have to differ.

Further, embodiments of the disclosed technology improve upon the following limitations:
Login Account Name and Password alone does not provide enough security.
MFA alone does not provide enough security.
Biometric alone does not provide enough security.
Secret answers to security questions alone does not provide enough security.
Sharing known data alone does not provide enough security.

Often, one form of identity verification is not enough. However, when identity verification methods are combined such as answers to questions plus MFA, the method of proving the identity of the person on the other end of the phone becomes a lot stronger. Often, MFA plus another form of verification can be sufficient for most use cases. Adding some form of voice, or finger or face biometric to the verification equation can be even stronger.

Most organizations have their own user authentication challenges and their own means of securing corporate assets. User authentication technology has become more sophisticated, but there can still be a need for remote/remotely-assisted interaction (e.g., with a person) for employee authentication.

Embodiments of the disclosed technology address the following scenarios. That is, one of the lessons learned from supporting work-from-home employees or contract vendors during the pandemic is that securing remote user access can be difficult. When an enterprise has employees working remotely the enterprise needs to give them fast, secure access to the corporate apps and resources they need for them to stay productive, which embodiments herein provide. Remote workers need access to new corporate resources fast but how can the enterprise know or confirm that they are the people they say they are? Embodiments of the disclosed technology provide an answer to this question.

To maintain both secure access and productivity, authentication may need to be seamless and frictionless, but with added safeguards in place that can be applied when needed, which is provided by embodiments of the disclosed technology.

For companies that have adopted a leading MFA provider with open application programming interfaces (API's), embodiments of the disclosed technology provide delegated services (e.g., a help desk service) to validate a workforce by a user calling the services. Embodiments of the disclosed technology address this use case by sending an MFA challenge to a remote worker to confirm their identity. This challenge can be combined with answers to semi-private questions as well as data the organization has on the remote worker.

Embodiments of the disclosed technology allow an organization to integrate remote/remotely-assisted authentication (e.g., HAA) into enterprise security.

One concept behind this kind of identity verification is to easily verify contacts using remote authentication to eliminate identity spoofing and provide a needed layer of security. It is an optimal way to protect sensitive data and software assets while minimizing delays, computer resources, and computer latency, and optimizing the user experience.

Rather than continuing to rely solely on answering questions provided by a customer service representative retrieving the questions from an enterprise database, there might be times when an organization, an enterprise, or an entity needs that added layer of security to verify user identity and improve worker and resource productivity at the same time.

Some conventional systems use SMS communication to confirm the requestor's identity. However, the problem with this approach is that the authentication data can be faked. A copy of the SIM card could have been made. The mobile device could have been stolen. And other such examples exist.

Currently, the present day steps required for the remote worker to be authenticated is not secure and takes many new actions that are not already part of the organization's actions on their systems, including creating and storing new identification data for many workers.

When many workers across the globe are in the process of authenticating via a CSR, a lot of processing cost is had, a lot of server charges are made by the CSR to look up this additional identification data, and a lot of data is going back and forth between the CSR and this stored ID data, which could be across the Internet.

These events directly affect the performance of the CSR's computer and the remote worker computerized device. The Internet can slow down. The organization's website can slow down. There can be a problem of load management for the CSR and the remote worker.

The disclosed technology described herein solves the problem by improving the processing time for authentication technology, timewise and processing cost-wise. In addition, techniques described improve digital user-consumption technology and improve user-convenience. Now, instead of the viewer imposing many costs on the Internet channel or the organization's network, as described above, the CSR can cause the remote worker to be authenticated using the existing MFA system, itself.

### Methods and Processes of Remotely-Assisted Authentication

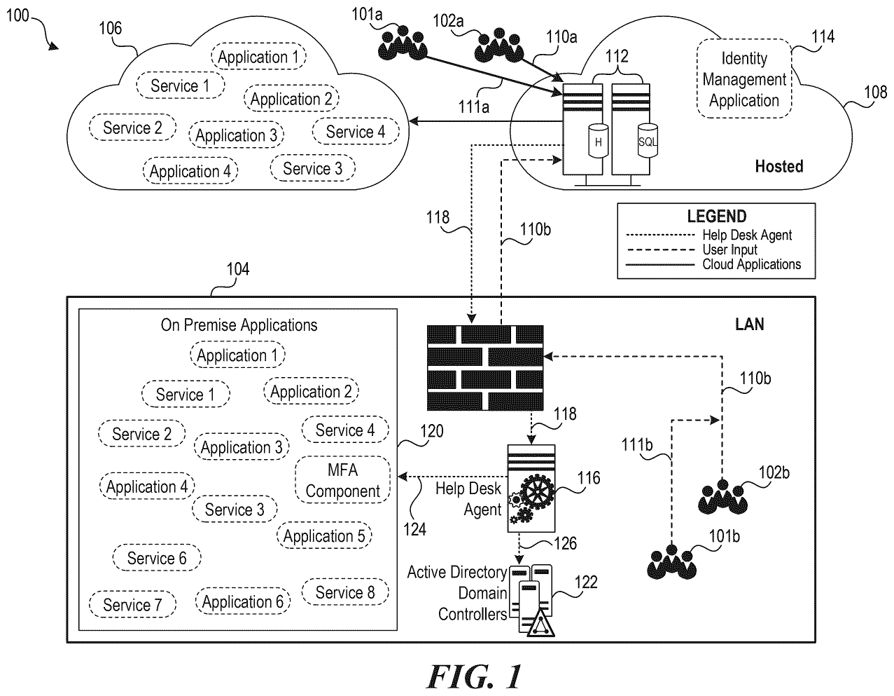

FIG. 1 is a schematic diagram of an application container hosted system 100 for remote authentication using an MFA of an enterprise (a type of standardized MFA.), in accordance with embodiments of the disclosed technology. FIG. 1 depicts a remote user 102a (e.g., a remote worker) from outside the local area network (LAN) 104 of the company (or other on-premises entity) and the remote user 102b from inside the LAN 104. Users 102a and/or 102b desire to logon to a cloud application or service 106 or on-premises applications 120.

Examples of cloud applications can include familiar brand name applications, but it should be understood that such cloud applications are by example only and are not meant to be limiting. It should further be appreciated that each of cloud applications 106 has previously obtained and deployed the representational state transfer (REST) APIs provided by the host application container system.

However, as discussed above, at times the remote users 102a and/or 102b need to be authenticated to have permission to the applications (e.g., cloud applications 106 and/or on-premises applications 120). Thus, in accordance with embodiments herein, users 102a and/or 102b call remote authenticators 101a and/or 101b (also referred to as “authenticators”), respectively. In some embodiments, remote authenticators 101a and/or 101b can include people (e.g., customer service representatives (CSR's)), and/or machine learning/artificial intelligence networks and/or systems. By way of example only, the discussion of FIG. 1 herein will use “CSRs” to represent the remote authenticators 101a and/or 101b. Although there are no connection lines between 101a and 102a nor 101b and 102b, one skilled in the art would readily appreciate that a variety of communicative connections are contemplated (e.g., mobile device, landline, Wi-Fi connectivity, short range communications, etc.). CSRs 101a and/or 101b then request that the remote workers 102a and/or 102b confirm their identity. In one embodiment, CSRs 101a and/or 101b make such requests via connection 111a to an identity management application container 112 or via connection 111b to communication channel 110b to the identity management application container 112. In some embodiments, the request goes to the enterprise's on-premises MFA component as shown in 120. The MFA component is configured to identify the remote worker ID based on data sent either by the CSRs 101a and/or 101b or via the original or subsequent request by remote workers 102a and/or 102b. The MFA component, which had been previously configured with challenges for remote workers 102a and/or 102b, is further configured to send MFA-related challenges to remote workers 102a and/or 102b for the purpose of provisioning additional access, renewed access, or new access to the application. Once the remote workers 102a and/or 102b answer the challenge, in accordance with the enterprise's own MFA configuration and MFA policies, the CSRs 101a and/or 101b are able to further ask the remote workers 102a and/or 102b questions to answer, thereby proving the identity of the person on the other end of the phone, e.g., the remote worker.

Once the remote workers 102a and/or 102b are authenticated, the remote workers 102a and/or 102b can use the resource requested on the enterprise's site.

Going forward, the remote user can access the enterprise's cloud applications as depicted in FIG. 1. That is, when users 102a and/or 102b begin logging into one of cloud applications 106, users 102a and/or 102b send the login request to host application container web server 108. The user input initiating the login process by users 102a and/or 102b is depicted by communication channel 110a and communication channel 110b (e.g., lead lines), respectively. Communication channel 110b is shown going through the company's firewall. The user input reaches host application container web server 108 and the appropriate application container 112, depicted as logical devices, where one of the logical devices is depicted as a SQL database and the other is depicted as a health record (H) application container. The dashed box 114 labeled “Identity Management Application” represents that the application container 112 is running the identity management application. Thus, in response to the user input the running identity management container application 114 sends a corresponding login request 118 to an identity management agent 116 that was previously installed or downloaded by the company. Lead lines 118 represent the login request originating from the user but intercepted by the identity management application container 112. Subsequently, agent 116 contains the actual identity management container application and is configured to communicate as shown via lead line 124 with the on-premises applications 120 and/or one or more active direct domain controllers 122 as shown via lead line 126 to authenticate and authorize users 102a and/or 102b. In an embodiment, agent 116 communicates with host application container web server 108 using the APIs, such as for example the REST APIs, described above. In an embodiment, agent 116 is already configured with identity management code to authenticate users 102a and/or 102b, as if it were an on-premises identity authentication application, itself. Put another way, agent 116 can contain an identity management application that was previously used to by the company to authenticate its users, but now ported to agent 116. The positive (or negative) authentication is relayed back to the application container 112 running the identity management application 114 via the same communication channels (e.g., lead lines 118) but in the opposite direction. After receiving the positive authentication notification originating from agent 116, application container 112 allows users 102a and/or 102b to logon to the desired cloud application of cloud applications 106.

In some embodiments, examples of employees working remotely can be presented with challenges for accessing cloud applications, resetting forgotten passwords, and identity management. Often, identity management and governance solutions cannot accommodate the work-from-anywhere new world. There is a need to secure remote work access. Embodiments described herein provide more control over all enterprise access and access requests. In some embodiments, because the system and processes described herein can be always on, such systems and processes enable push or ping notifications for urgent requests from anyone (application owners, managers, or IT personnel), anywhere, to users who can quickly approve these requests. The disclosed systems and processes give employees secure access to the resources they need when they need them.

In some embodiments, the type of push or ping notification can be customized. For instance, in some embodiments, the notification is a screen upon which the device user is asked to perform a particular swipe thereon. Or the notification is a question asking the device user to select either “Agree” or “Disagree”. Or the device user may be asked to read off a random number to the CSR, where the random number was generated by the enterprise's own MFA system. One skilled in the art would readily recognize that the specific screen implementations for the enterprise-specific MFA challenge are vast and can be encompassed by the disclosed technology discussed herein.

The disclosed technology provides single sign on for enterprises (e.g., Microsoft Teams) with native integration, which makes the enterprise deployment instant. That is, the disclosed technology leverages existing authentication application installations, including their native MFA systems.

In accordance with embodiments herein, the requests work securely and efficiently through workflow (e.g., over a cell phone) by using a shopping cart experience to choose and access enterprise resources and get push notifications to approve access.

In some embodiments the system 100 is configured to operate access governance by enabling access reviews from anywhere anytime, for example, by using any mobile interface and by getting push notifications when a review started or when an exception is allowed, when credentials are revoked or when reviews are reassigned to the user.

Advantages of the system 100 include reducing information technology (IT) requests, strengthening digital security, and gaining workforce efficiency.

The disclosed technology system 100 is configured to eliminate layers of complexity and administration by enabling an enterprise to keep their identity data on-premise but their identity solution in the cloud and by enabling a CSR to cause a push notification from the enterprise's MFA to the remote worker/requester requesting access to enterprise resources.

Embodiments of the disclosed technology provide a technical solution to the problem of not knowing or not being able to verify/confirm that an individual is who they say they are. For example, if a remote worker said that they are John Doe, how does the CSR know that they are John Doe? In accordance with the embodiment, the CSR can cause an MFA-associated challenge (from the enterprise's own MFA system) to the person making the request for that person to answer. Thus, if and when the MFA challenge is satisfied, then the CSR knows that the requestor is who they said they were (i.e., a legitimate and authenticated worker).

In some embodiments, the system 100 is configured to enable the person initiating the verifying process (e.g., the CSR 101a and/or 101b) to select one option or a combination of options for authenticating the requestor. For example, the system can be customized for each enterprise and their CSR according to their needs or desires. For instance, the system can be configured for the CSR to cause the MFA to send only one challenge to the requestor. In another instance, the system can be configured for the CSR to cause the MFA to send two challenges to the requestor and also ask the requestor some predefined questions.

In some embodiments, the workforce calls their own helpdesk, which uses the system 100 to confirm the ID of the caller, the system 100 using the organization's MFA component in addition to questions and answers.

In some embodiments, proprietary client applications are provided by an agent system (e.g., host application container web server 108). The remote worker's device and the CSR's device are each configured with client applications so that they can each be communicably configured to receive and transmit data from and to the enterprise's MFA component (e.g., as depicted in FIG. 1). For example, the remote worker's client application causes the MFA push or ping notifications to display. As another example, the CSR's client application communicates the request for MFA authentication to the MFA system.

In some embodiments, the system 100 is configured so that the on phone experience is the same as in front of computer. For example, an employee who is sitting in front of a computer, requesting access to a resource of an organization while communicably connected to the organization's network, would have authenticated via the organization's own MFA system. The disclosed technology allows the same user to authenticate using the same organization's own MFA system but while being remote and using a remote device such as the user's own smartphone.

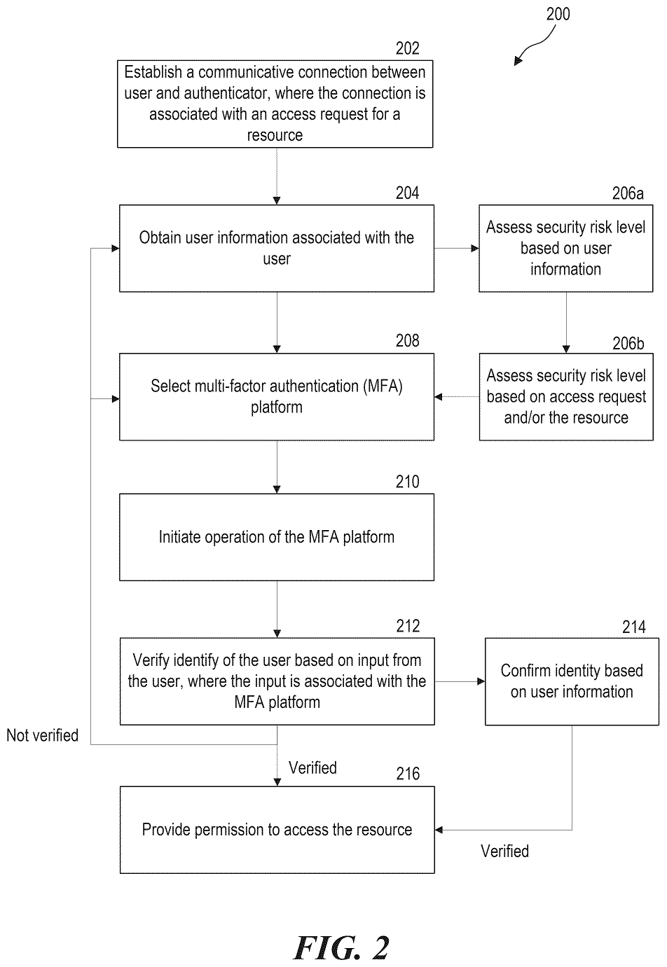

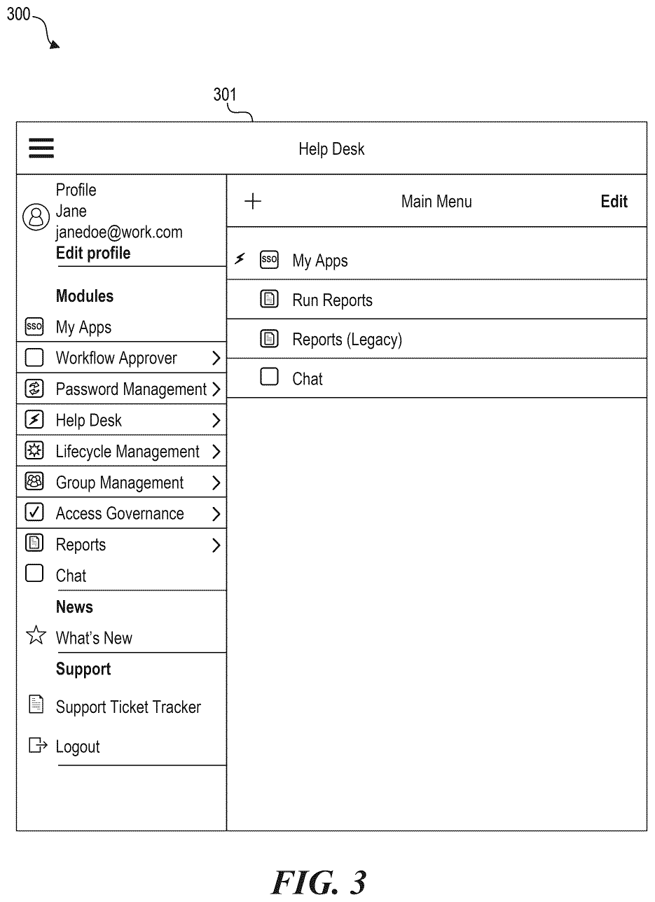

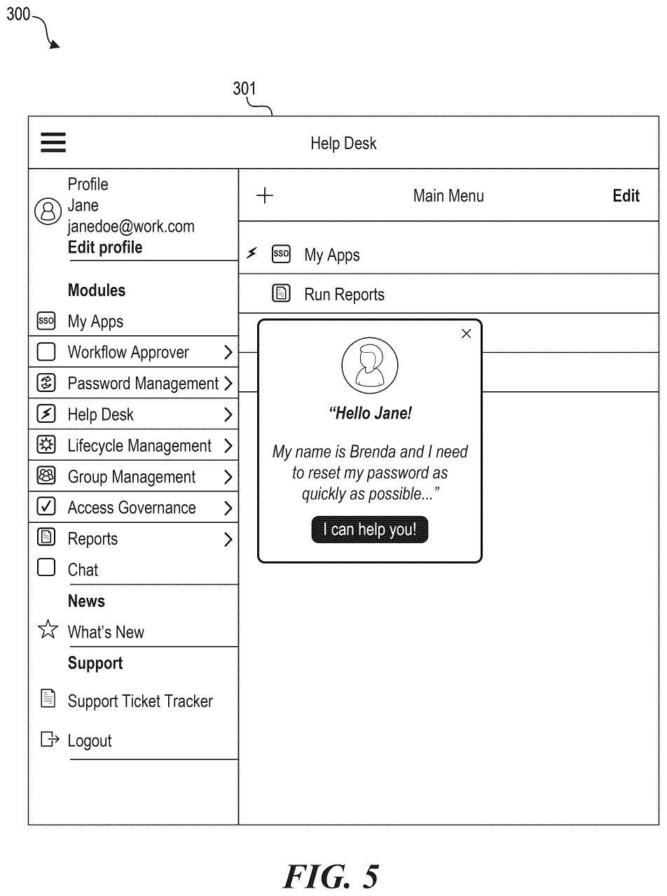

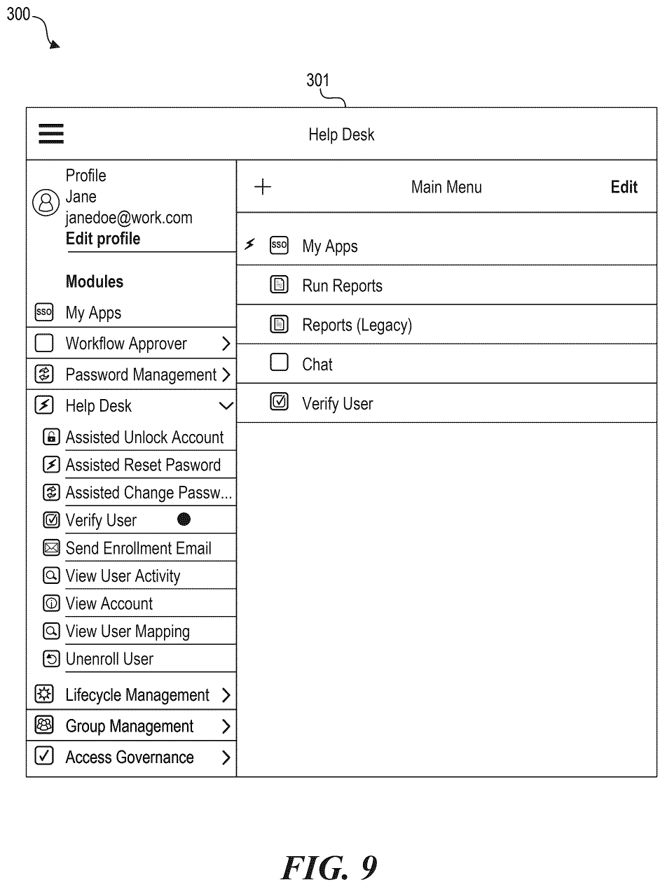

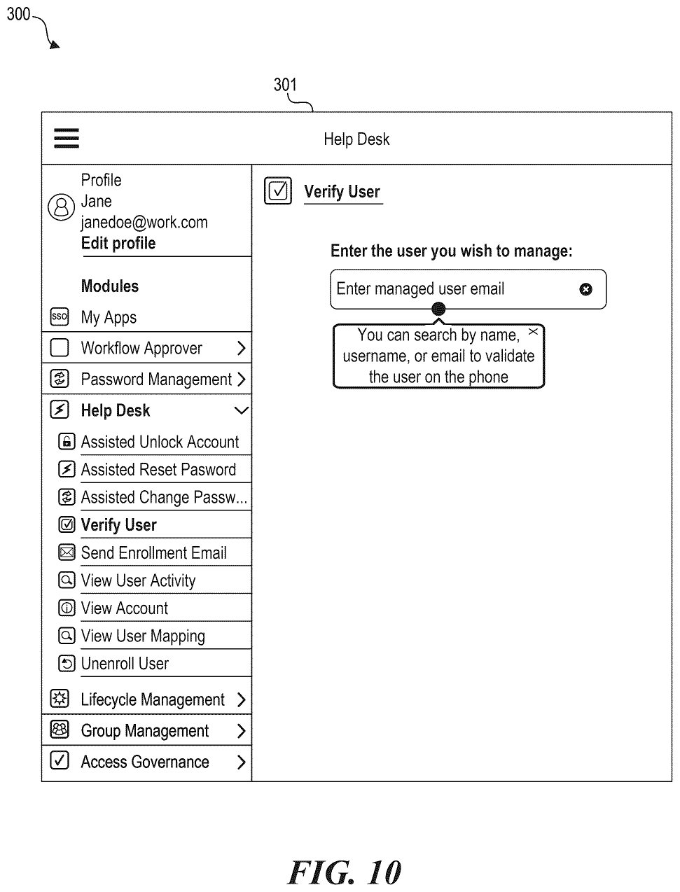

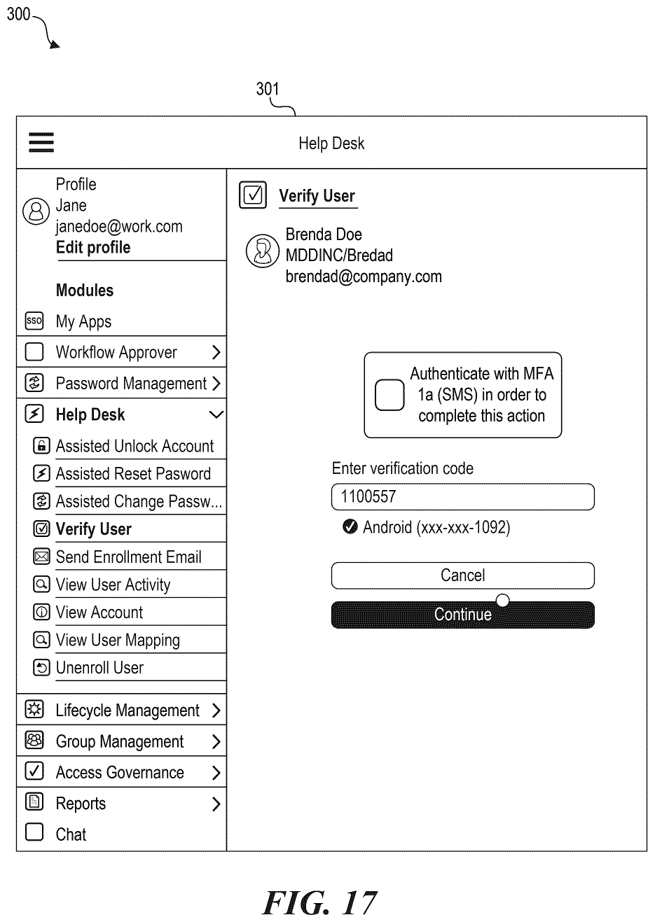

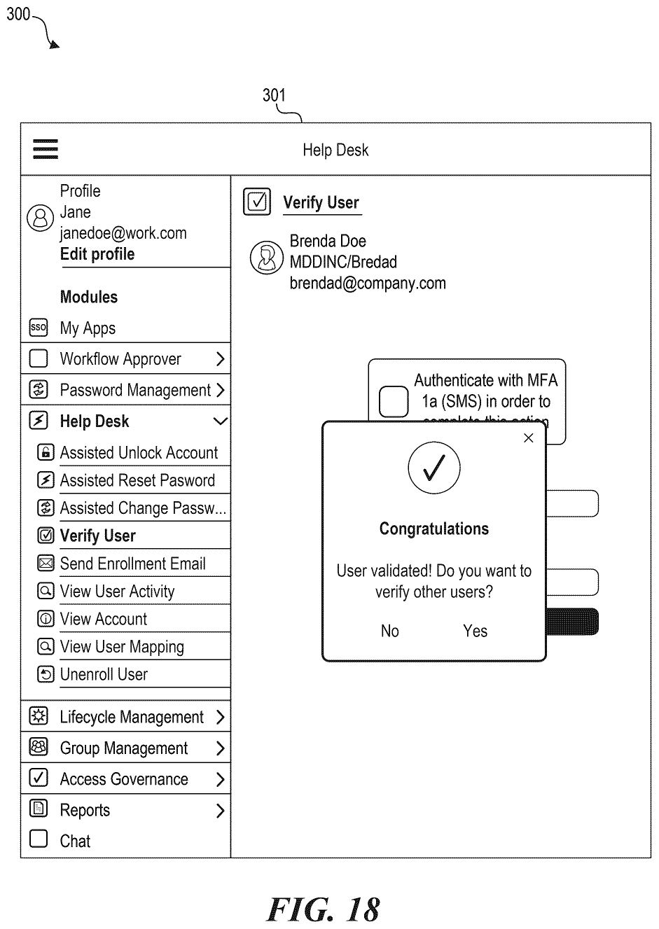

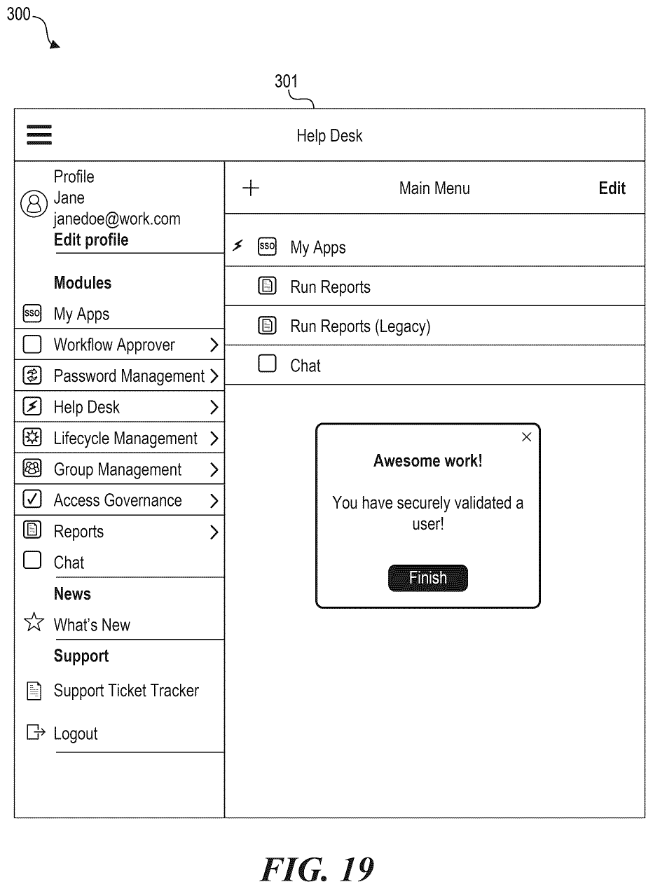

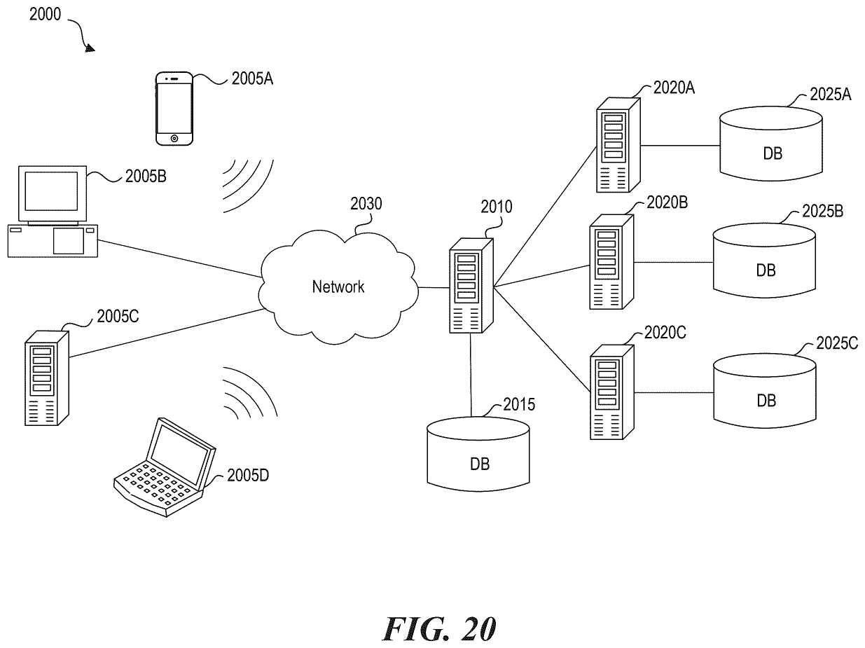

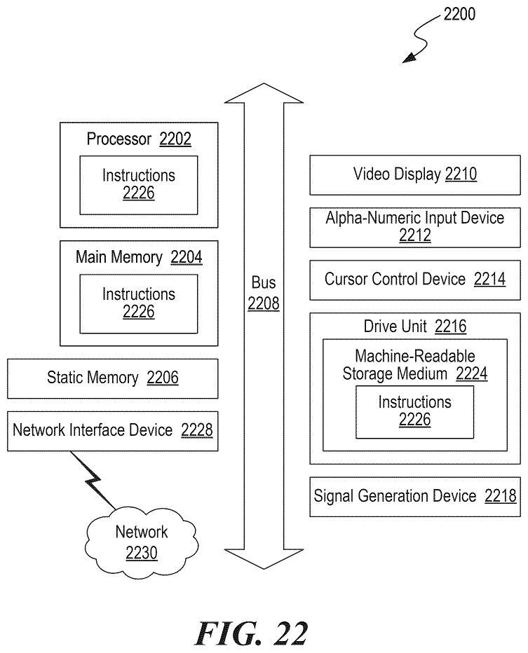

FIG. 2 is a method 200 of remotely authenticating access to enterprise resources, in accordance with embodiments of the disclosed technology. In some embodiments, one or more method 200 is implemented via one or more features of system 100 of FIG. 1, one or more features of process 300 of FIGS. 3-19, one or more features of environment 2000 of FIG. 20, one or more features of ML system 2100 of FIG. 5, and/or one or more features of computer system 2200 of FIG. 22.

At block 202, a communicative connection is established between a user and an authenticator (e.g., remote authenticator 101a and/or 101b described in FIG. 1). The communicative connection is associated with an access request for a resource of the enterprise. For example, the access request can be for financial information, health record information, proprietary information, or any other information associated with the user and/or the enterprise. In some embodiments, the authenticator is a person (e.g., in an HAA system). In some embodiments, the authenticator implemented as a machine learning and/or artificial intelligence system. In some embodiments, the access request is an affirmative request from the user to the authenticator to obtain access to the resource.

At block 204, user information is obtained by the authenticator. The user information is information associated with the user, such as name, age, birth date, social security number, phone number etc. In some embodiments, the user information is information stored in a database (public or private) to which the authenticator has access. For example, the authenticator can pull up information associated with the user via an application or software tool that the user has registered personal information with, such as some MFA with open API. The authenticator can pull up user information registered with that particular MFA. In some embodiments, the authenticator can obtain the information from the user directly (e.g., via the communicative connection). In some embodiments, the user information can be obtained by the authenticator accessing registered information from the enterprise that controls the resource being requested. For example, the enterprise can provide to the authenticator employee information associated with the user, such as an employee email, employee identification number, employee username, job title, and the like. In such embodiments, the authenticator can retrieve the user information directly from an enterprise database to which the authenticator has access, and/or via information stored in a server controlled by the enterprise and/or by the host application container (e.g., 108 of FIG. 1).

In some embodiments, as shown by block 206a, a security risk level (e.g., a first security risk level) is assessed (e.g., in situ by the authenticator, or on a pre-determined basis such as via a look-up table) based on the user information. For example, based on the employee identification number of the user, a relatively low security risk level can be assessed for the employee associated with that identification number. In some embodiments, as shown by block 206b, a security risk level (e.g., a second security risk level) is assessed based on the access request and/or the resource being requested. For example, an access request for health record information can be assessed to have a relatively high security risk level, compared to an access request for a username.

At block 208 an MFA platform is selected by the authenticator based at least in part on the user information (e.g., an employee email, the user's name, etc.). For example, the authenticator can determine that the user is registered with an MFA platform with an open API, and use that information to select that MFA platform. As another example, the authenticator can select an SMS MFA platform based on a phone number of the user.

In some embodiments, the authenticator selects an MFA that has been pre-approved by the enterprise to use for identity verification. This can include, for example an MFA component of on-premises applications of the enterprise (e.g., on-premises applications 120 of FIG. 1), and/or an MFA platform that is operated/controlled separately from the enterprise but that is nonetheless approved by the enterprise for verification. For example, where a first MFA platform is an enterprise MFA platform, and a second MFA is an unaffiliated (with the enterprise) MFA platform to which the user is registered, the authenticator can select one or both of the first MFA platform and/or the second MFA platform to verify the identity of the user.

In some embodiments, the authenticator can require and cause the user to at least begin enrollment in a particular MFA platform, which the authenticator can then select for verification of the user's identity. For example, where the enterprise requires a particular MFA platform based on the resource being requested, but the user is not enrolled or registered with that MFA platform, the authenticator can initiate the steps necessary to at least begin the enrollment in the MFA platform before the authenticator proceeds with the access request.

In some embodiments, the authenticator selects an MFA platform based on one or more of the user information, the user, the resource being requested, and/or the access request. For example, the user can request access to certain financial information associated with the user. The enterprise and/or the authenticator can have previously determined that financial information of that type requires two or more MFA platform selections. The authenticator can thus choose first and second MFA platforms with which to verify the identity of the user.

In some embodiments, the authenticator can select the one or more MFA platforms based on the assessed security risk levels determined in blocks 206a and/or 206b. That is the authenticator can select one or more MFA platforms based on the security risk level associated with the user and/or user information, and/or based on the access request and/or resource being requested. For example, where the user is requesting access to a certain type of health record information, and the user has not previously registered user information with the enterprise controlling the health record information, or the user has not been determined to be a pre-approved accessor of the health record information, the user can still access the health record information through a higher security protocol than would otherwise be administered if they were pre-approved or had registered. The health record information can be associated with a given risk security level. For example, the name and contact information of the subject of the health record information can have a relatively low security risk level (requiring, for example, verification via only a single MFA platform unaffiliated with the enterprise), while details of a particular medical condition can have a relatively high security risk level (requiring, for example, verification via two or more MFA platforms, both of which are affiliated with the enterprise).

In some embodiments, the authenticator can select the MFA platform based on the resource being requested. For example, where the user requests a username or password, the authenticator can select a none-enterprise-affiliated MFA platform to which the user is registered, or an SMS verification platform. If the user requests financial information, the authenticator can select an enterprise-approved MFA platform designated by the enterprise to be used for access requests for such financial information.

At block 210, operation of the selected MFA platform (or platforms) is initiated by the authenticator. For example, the authenticator can cause the selected MFA platform to send a security code to the phone of the user. At block 212, the identity of the user is verified based on input provided from the user, where the input is associated with the selected MFA platform. For example, the user can read off the security code sent to the user's phone (or otherwise provide the code to the authenticator), indicating to the authenticator that the user is who they claim to be. Once the authenticator has verified the identity of the user via the input associated with operation of the MFA platform, the authenticator can provide permission to the user to access the requested resource, as shown at block 216. If the identity of the user is not verified (for example, where the user provides an incorrect code, and/or where additional verification is necessitated based on the user information, resource and/or access request, and/or assessed security risk level), the authenticator can iteratively repeat the verification process beginning with blocks 204 and/or 208.

In some embodiments the identity of the user is confirmed via an additional layer of security, as shown at block 214. For example, after the user has correctly provided the code to the authenticator, the authenticator can then ask the user to confirm their identity by answering questions associated with the user information available to the authenticator and/or obtained at block 204 (e.g., birth date, SSN, employee ID number, etc.).

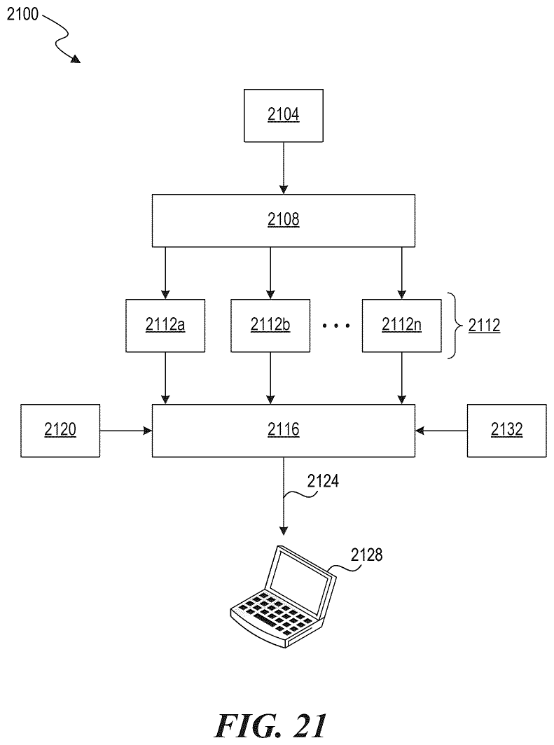

FIGS. 3-19 are illustrations of a remote authentication interface 301 and process 300 for validating a user, in accordance with embodiments of the disclosed technology. In embodiments, the interface 301 and the process 300 are implemented via one or more features and/or components of system 100 of FIG. 1, environment 2000 of FIG. 20, ML system 2100 of FIG. 21, and/or computer system 2200 of FIG. 22. In some embodiments, the interface 301 and process 300 are implemented via a distributed service configured to provide identity verification services to enterprises, depicted in FIGS. 3-19 as “Help Desk”.

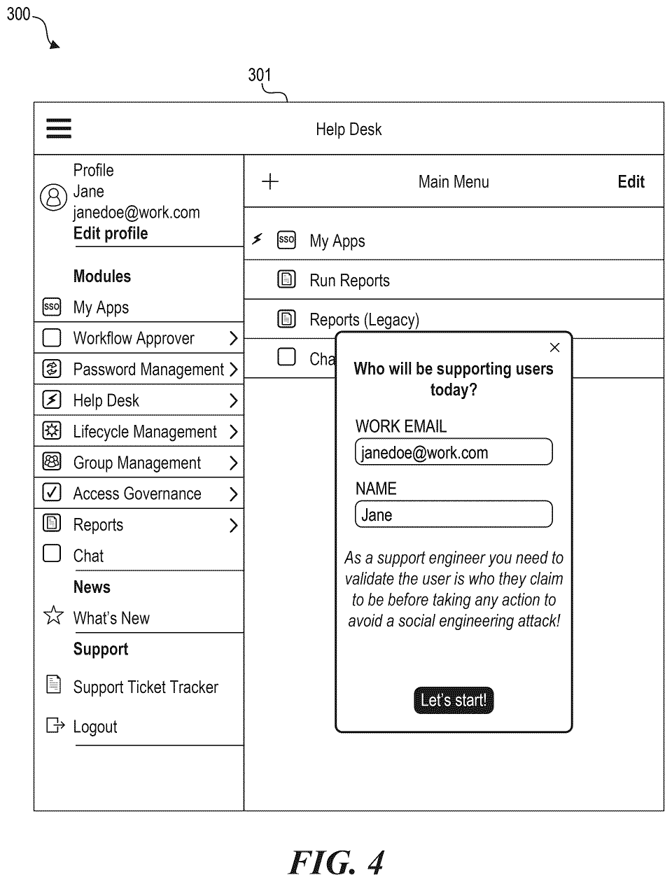

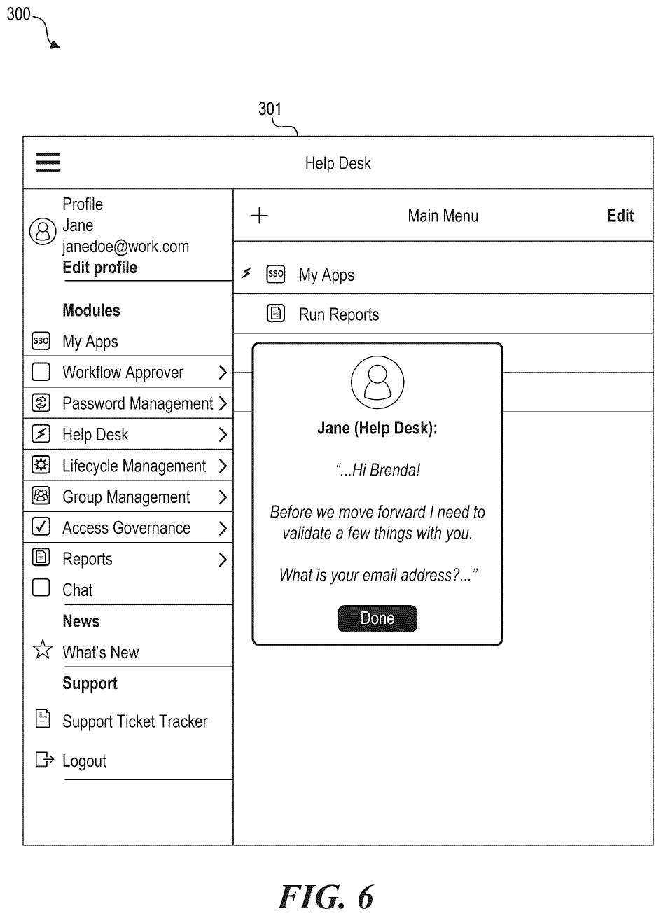

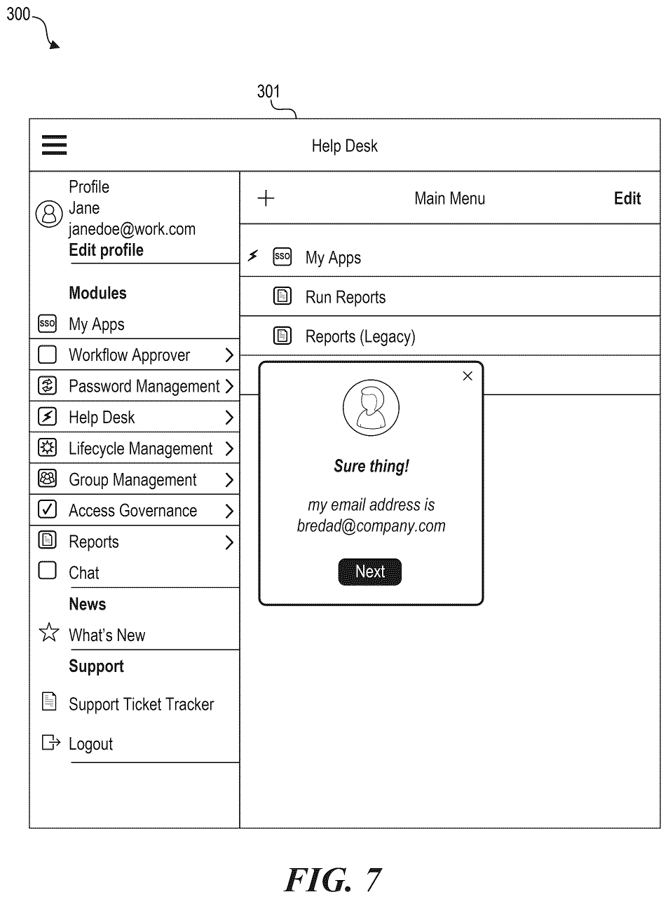

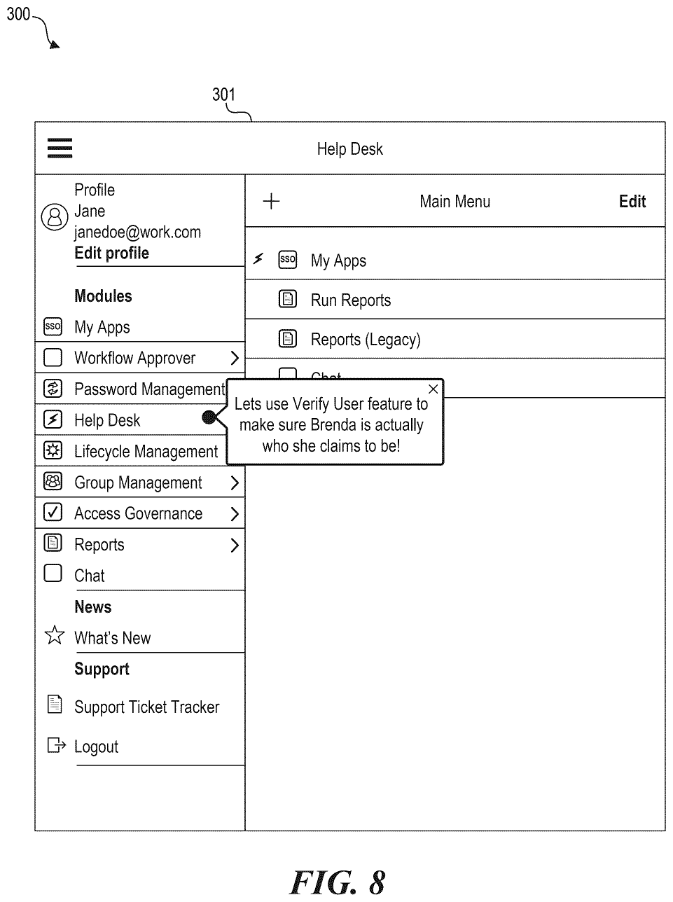

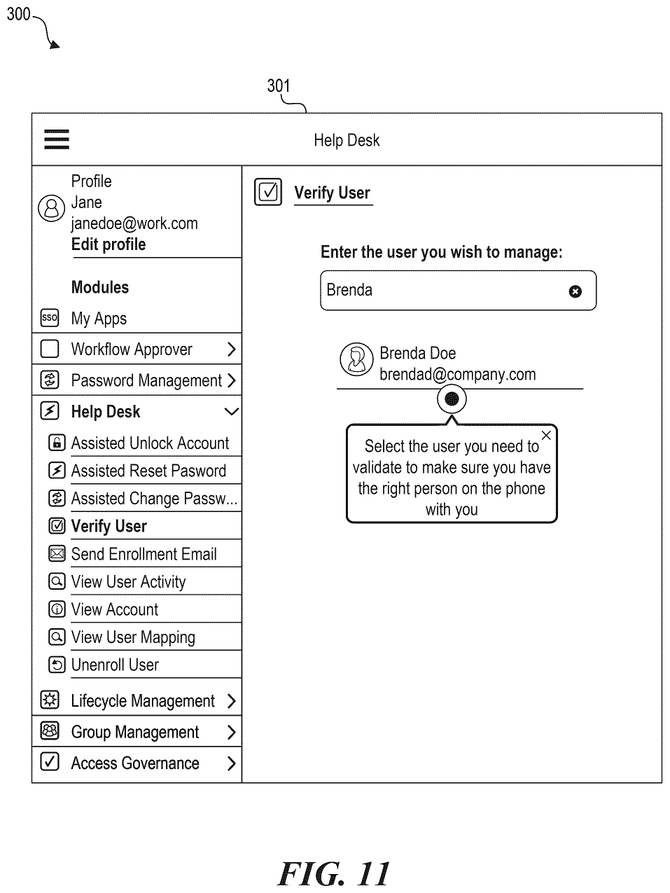

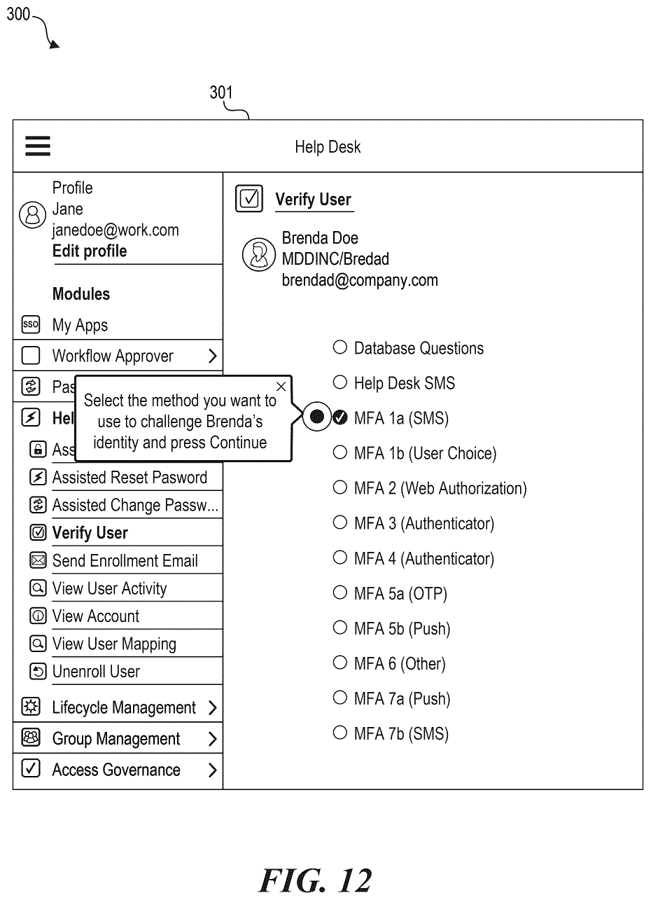

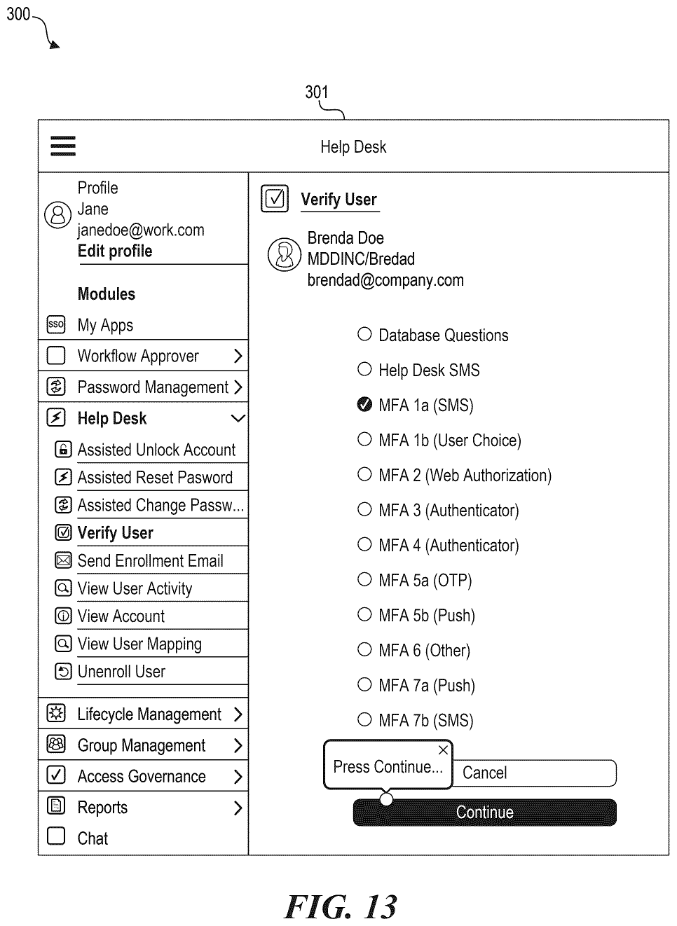

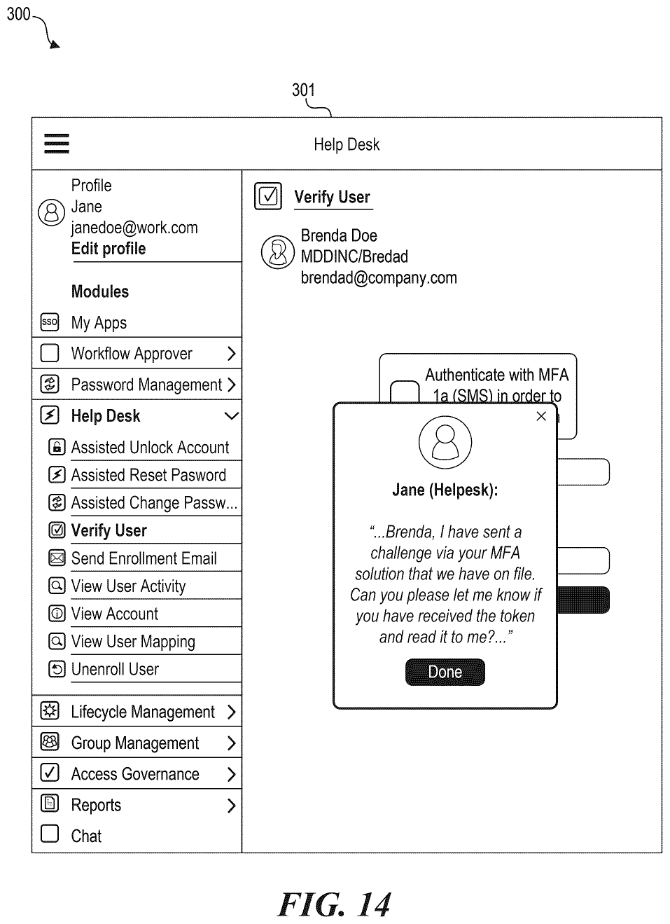

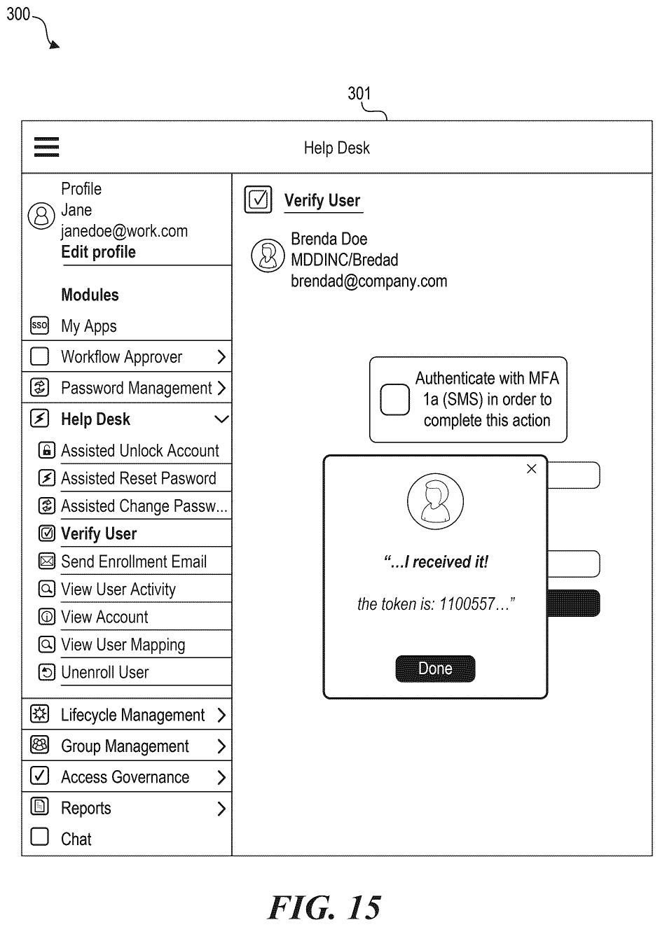

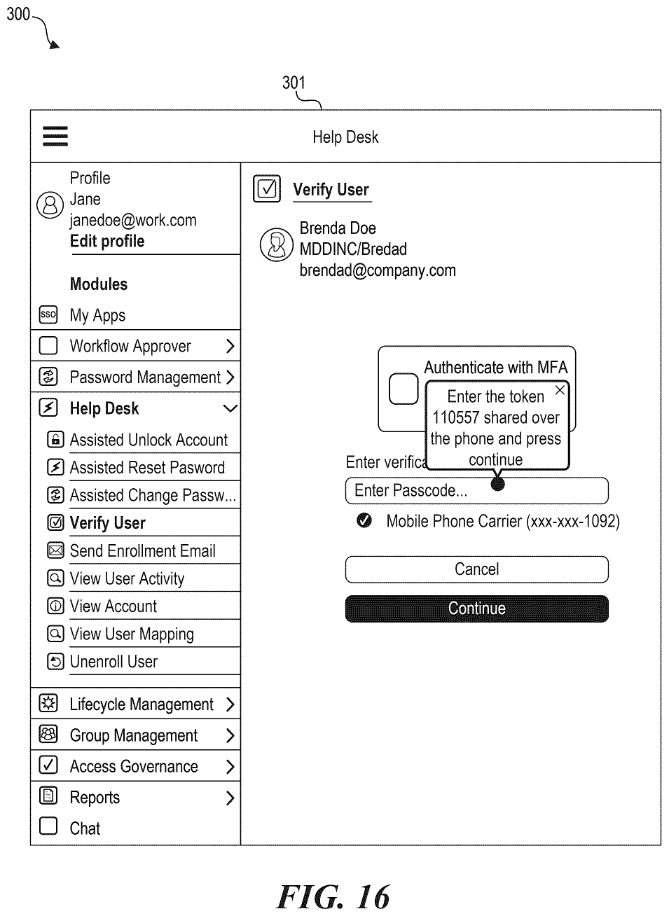

FIG. 3 shows the interface 301, which is operated by the authenticator. In some embodiments, FIG. 4 shows an authenticator, “Jane Doe” logging into the Help Desk identity verification platform, which includes the interface 301. FIG. 5 shows a user, “Brenda Doe” establishing a communicative connection with Jane Doe (e.g., via a telephone call and/or instant messaging functionality associated with the Help Desk, etc.). Brenda Doe requests assistance with resetting a password associated with her enterprise account. FIG. 6 shows Jane Doe obtaining user information from Brenda Doe that is associated with Brenda Doe's affiliation with the enterprise (i.e., Brenda Doe's employee email address). FIG. 7 shows Brenda Doe communicating her employee email address to Jane Doe. FIGS. 8-10 show Jane Doe bringing up a “Verify User” feature of the Help Desk interface 301. FIG. 11 shows Jane Doe typing Brenda Doe's employee email into the interface 301, and selecting the associated employee. FIGS. 12 and 13 show Jane Doe selecting an MFA platform from a menu of verification processes and MFA platforms which can be used to verify Brenda Doe's identity (e.g., MFA platforms which Brenda Doe is registered/enrolled with). Jane Doe selects “MFA 1a (SMS) to send a token via SMS to Brenda Doe's telephone. FIG. 14 shows Jane Doe operating the selected MFA platform to send the token, and requesting that Brenda Doe provide information associated with the token once Brenda Doe receives it. FIG. 15 shows Brenda Doe providing information associated with the token (i.e., the numeric code “110057 . . . ” to Jane Doe. FIGS. 16-19 show Jane Doe verifying the identity of Brenda Doe via the information provided by Brenda Doe to Jane Doe.

### Computing Environment and Machine Learning

FIG. 20 is a system diagram illustrating an example of a computing environment 2000 in which the disclosed system operates in some embodiments. In some embodiments, environment 2000 includes one or more client computing devices 2005A-D, examples of which can host the computer system 2200 discussed further with reference to FIG. 22, and/or ML system 2100, discussed further with reference to FIG. 21. In some embodiments, one or more portions of the system 100 of FIG. 1, method 200 of FIG. 2, and/or process 300 of FIGS. 3-19 are implemented via computing environment 2000. Client computing devices 2005 operate in a networked environment using logical connections through network 2030 to one or more remote computers, such as a server computing device.

In some embodiments, server 2010 is an edge server which receives client requests and coordinates fulfillment of those requests through other servers, such as servers 2020A-C. In some embodiments, server computing devices 2010 and 2020 comprise computing systems, such as the system 2200. Though each server computing device 2010 and 2020 is displayed logically as a single server, server computing devices can each be a distributed computing environment encompassing multiple computing devices located at the same or at geographically disparate physical locations. In some embodiments, each server 2020 corresponds to a group of servers.

Client computing devices 2005 and server computing devices 2010 and 2020 can each act as a server or client to other server or client devices. In some embodiments, servers (2010, 2020A-C) connect to a corresponding database (2015, 2025A-C). As discussed above, each server 2020 can correspond to a group of servers, and each of these servers can share a database or can have its own database. Databases 2015 and 2025 warehouse (e.g., store) information such as enterprise resources, employee/user information, MFA platforms, user information registered with one or more MFA platforms, assessed security risk levels and risk information associated with the enterprise resources, enterprise applications, enterprise services, and so on. Though databases 2015 and 2025 are displayed logically as single units, databases 2015 and 2025 can each be a distributed computing environment encompassing multiple computing devices, can be located within their corresponding server, or can be located at the same or at geographically disparate physical locations.

Network 2030 can be a local area network (LAN) or a wide area network (WAN), but can also be other wired or wireless networks. In some embodiments, network 2030 is the Internet or some other public or private network. Client computing devices 2005 are connected to network 2030 through a network interface, such as by wired or wireless communication. While the connections between server 2010 and servers 2020 are shown as separate connections, these connections can be any kind of local, wide area, wired, or wireless network, including network 2030 or a separate public or private network.

FIG. 21 is a block diagram illustrating an example ML system 2100, in accordance with one or more embodiments. The ML system 2100 is implemented using components of the example computer system 2200 illustrated and described in more detail with reference to FIG. 22. Different embodiments of the ML system 2100 include different and/or additional components and are connected in different ways. The ML system 2100 is sometimes referred to as a ML module. In some embodiments, one or more portions of the system 100 of FIG. 1, method 200 of FIG. 2, and/or process 300 of FIGS. 3-19 are implemented via ML system 2100.

The ML system 2100 includes a feature extraction module 2108 implemented using components of the example computer system 2200 illustrated and described in more detail with reference to FIG. 22. In some embodiments, the feature extraction module 2108 extracts a feature vector 2112 from input data 2104. For example, the input data 2104 enterprise resources, employee/user information, MFA platforms, user information registered with one or more MFA platforms, assessed security risk levels and risk information associated with the enterprise resources, enterprise applications, enterprise services and the like. The feature vector 2112 includes features 2112a, 2112b, . . . , 2112n. The feature extraction module 2108 reduces the redundancy in the input data 2104, for example, repetitive data values, to transform the input data 2104 into the reduced set of features 2112, for example, features 2112a, 2112b, . . . , 2112n. The feature vector 2112 contains the relevant information from the input data 2104, such that events or data value thresholds of interest are identified by the ML model 2116 by using a reduced representation. In some example embodiments, the following dimensionality reduction techniques are used by the feature extraction module 2108: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 2116 performs deep learning (also known as deep structured learning or hierarchical learning) directly on the input data 2104 to learn data representations, as opposed to using task-specific algorithms. In deep learning, no explicit feature extraction is performed; the features 2112 are implicitly extracted by the ML system 2100. For example, the ML model 2116 uses a cascade of multiple layers of nonlinear processing units for implicit feature extraction and transformation. Each successive layer uses the output from the previous layer as input. The ML model 2116 thus learns in supervised (e.g., classification) and/or unsupervised (e.g., pattern analysis) modes. The ML model 2116 learns multiple levels of representations that correspond to different levels of abstraction, wherein the different levels form a hierarchy of concepts. The multiple levels of representation configure the ML model 2116 to differentiate features of interest from background features.

In alternative example embodiments, the ML model 2116, for example, in the form of a CNN generates the output 2124, without the need for feature extraction, directly from the input data 2104. The output 2124 is provided to the computer device 2128. The computer device 2128 is a server, computer, tablet, smartphone, etc., implemented using components of the example computer system 2200 illustrated and described in more detail with reference to FIG. 22. In some embodiments, the steps performed by the ML system 2100 are stored in memory on the computer device 2128 for execution. In other embodiments, the output 2124 is displayed on electronic displays of the computer device 2128.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 2116 is a CNN that includes both convolutional layers and max pooling layers. For example, the architecture of the ML model 2116 is “fully convolutional,” which means that variable sized sensor data vectors are fed into it. For convolutional layers, the ML model 2116 specifies a kernel size, a stride of the convolution, and an amount of zero padding applied to the input of that layer. For the pooling layers, the model 2116 specifies the kernel size and stride of the pooling.

In some embodiments, the ML system 2100 trains the ML model 2116, based on the training data 2120, to correlate the feature vector 2112 to expected outputs in the training data 2120. As part of the training of the ML model 2116, the ML system 2100 forms a training set of features and training labels by identifying a positive training set of features that have been determined to have a desired property in question, and, in some embodiments, forms a negative training set of features that lack the property in question.

The ML system 2100 applies ML techniques to train the ML model 2116, that when applied to the feature vector 2112, outputs indications of whether the feature vector 2112 has an associated desired property or properties, such as a probability that the feature vector 2112 has a particular Boolean property, or an estimated value of a scalar property. In embodiments, the ML system 2100 further applies dimensionality reduction (e.g., via linear discriminant analysis (LDA), PCA, or the like) to reduce the amount of data in the feature vector 2112 to a smaller, more representative set of data.

In embodiments, the ML system 2100 uses supervised ML to train the ML model 2116, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 2132 is formed of additional features, other than those in the training data 2120, which have already been determined to have or to lack the property in question. The ML system 2100 applies the trained ML model 2116 to the features of the validation set 2132 to quantify the accuracy of the ML model 2116. Common metrics applied in accuracy measurement include Precision and Recall, where Precision refers to a number of results the ML model 2116 correctly predicted out of the total it predicted, and Recall is a number of results the ML model 2116 correctly predicted out of the total number of features that had the desired property in question. In some embodiments, the ML system 2100 iteratively re-trains the ML model 2116 until the occurrence of a stopping condition, such as the accuracy measurement indication that the ML model 2116 is sufficiently accurate, or a number of training rounds having taken place. In embodiments, the validation set 2132 includes data corresponding to confirmed mechanical properties and/or weightings/constants and combinations thereof. This allows the detected values to be validated using the validation set 2132. The validation set 2132 is generated based on the analysis to be performed.

FIG. 22 is a block diagram illustrating an example computer system 2200, in accordance with one or more embodiments. Components of the example computer system 2200 are used to implement one or more portions of the system 100 of FIG. 1, one or more portions of method 200 of FIG. 2, one or more portions of the process 300 described in FIGS. 3-19, and/or perform analysis and calculations described throughout his document. In some embodiments, components of the example computer system 2200 are used to implement the ML system 2100 illustrated and described in more detail with reference to FIG. 21, and/or the environment 2000 of FIG. 20. At least some operations described herein are implemented on the computer system 2200.

The computer system 2200 includes one or more central processing units (“processors”) 2202, main memory 2206, non-volatile memory 2210, network adapters 2212 (e.g., network interface), video displays 2218, input/output devices 2220, control devices 2222 (e.g., keyboard and pointing devices), drive units 2224 including a storage medium 2226, and a signal generation device 2220 that are communicatively connected to a bus 2216. The bus 2216 is illustrated as an abstraction that represents one or more physical buses and/or point-to-point connections that are connected by appropriate bridges, adapters, or controllers. In embodiments, the bus 2216, includes a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

In embodiments, the computer system 2200 shares a similar computer processor architecture as that of a desktop computer, tablet computer, personal digital assistant (PDA), mobile phone, game console, music player, wearable electronic device (e.g., a watch), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 2200.

While the main memory 2206, non-volatile memory 2210, and storage medium 2226 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 2228. The term “machine-readable medium” and “storage medium” shall also be taken to include any medium that is capable of storing, encoding, or carrying a set of instructions for execution by the computer system 2200.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 2204, 2208, 2228) set at various times in various memory and storage devices in a computer device. When read and executed by the one or more processors 2202, the instruction(s) cause the computer system 2200 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 2210, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 2212 enables the computer system 2200 to mediate data in a network 2214 with an entity that is external to the computer system 2200 through any communication protocol supported by the computer system 2200 and the external entity. In embodiments, the network adapter 2212 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 2212 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

I/we claim:

1. A method of remotely authenticating access to a resource of an enterprise, the method comprising:
establishing a communicative connection between a user and an authenticator, wherein the communicative connection is associated with an access request for the resource of the enterprise;
obtaining, by the authenticator, user information associated with the user;
selecting, by the authenticator, a multi-factor authentication (MFA) platform based at least in part on the user information;
initiating, by the authenticator, operation of the selected MFA platform;
verifying, by the authenticator, an identity of the user based at least in part on input provided by the user, wherein the input is associated with operation of the selected MFA platform; and
providing permission to access the resource of the enterprise in response to verification of the identity of the user.

2. The method of claim 1 wherein selecting the MFA platform is based at least in part on the resource of the enterprise.

3. The method of claim 1 wherein one or more MFA platforms are associated with the enterprise, and wherein selecting the MFA platform is based at least in part on the one or more MFA platforms associated with the enterprise.

4. The method of claim 1, further comprising:
assessing a first security risk level associated with the user, the first security risk level based at least part on the user information;
assessing a second security risk level associated with the resource of the enterprise, the second security risk level based at least part on the resource; and
selecting the MFA platform based at least in part on the first and second assessed security risk levels.

5. The method of claim 4, wherein the MFA platform is a first MFA platform, and the method further comprises selecting, by the authenticator, a second MFA platform based at least in part on the first and second assessed security risk levels, wherein the second MFA platform is different than the first MFA platform.

6. The method of claim 1 further comprising confirming, by the authenticator, the identity of the user based at least in part on user information obtained by the authenticator from the enterprise.

7. The method of claim 1 further comprising registering the user with the selected MFA platform.

8. The method of claim 1 wherein the user information associated with the user is registered with the enterprise prior to the access request, and wherein the user information includes one or more of: an employee email of the user, an employee identification number of the user, and/or a username of the user.

9. The method of claim 1 wherein the authenticator is an artificial intelligence and/or machine learning system trained on one or more of: enterprise resources, employee/user information, MFA platforms, user information registered with one or more MFA platforms, assessed security risk levels and risk information associated with the enterprise resources, enterprise applications, and/or enterprise services.

10. A system of remotely authenticating access to a resource of an enterprise, the system comprising:
an enterprise including one or more resources;
one or more processors; and
one or more memory devices having stored thereon instructions that when executed by the one or more processors cause the one or more processors to:
establish a communicative connection between a user and an authenticator, wherein the communicative connection is associated with an access request for at least one of the one or more resources of the enterprise;
provide, to the authenticator, user information associated with the user, wherein the user information is registered with the enterprise;
receive, from the authenticator, a selection of a multi-factor authentication (MFA) platform based at least in part on the user information;
initiate operation of the selected MFA platform;
transmit input from the user to the authenticator, wherein the input is associated with operation of the selected MFA platform; and
provide permission to access the one or more resources of the enterprise in response to the input from the user.

11. The system of claim 10 further comprising instructions to send a push notification to a mobile device of the user based on the selected MFA platform, and wherein the input transmitted from the user includes an indication that the user received the push notification.

12. The system of claim 10 wherein the selection of the MFA platform is based at least in part on the access request.

13. The system of claim 10 wherein one or more MFA platforms are associated with the enterprise, and wherein the selection of the MFA platform is based at least in part on the one or more MFA platforms associated with the enterprise.

14. The system of claim 10, further comprising instructions that cause the one or more processors to:
assess a first security risk level associated with the user, the first security risk level based at least part on the user information;
assess a second security risk level associated with the resource of the enterprise, the second security risk level based at least part on the resource; and
receive, from the authenticator, a selection of the MFA platform based at least in part on the first and second assessed security risk levels.

15. The system of claim 14, wherein the MFA platform is a first MFA platform, and the system further comprises instructions that cause the one or more processors to receive, from the authenticator, a selection of the second MFA platform based at least in part on the first and second assessed security risk levels, wherein the second MFA platform is different than the first MFA platform.

16. The system of claim 10 further comprising instructions that cause the one or more processors to confirm an identity of the user based at least in part on user information obtained by the authenticator from the user.

17. The system of claim 10 wherein the system further comprises instructions that cause the one or more processors to issue instructions to the user to register with the selected MFA platform.

18. A cloud-based computer-implemented method of remotely authenticating access to a resource of an enterprise, the method comprising:
establishing a communicative connection between a user and an authenticator, wherein the communicative connection is associated with an access request for the resource of the enterprise;
selecting, by the authenticator, a multi-factor authentication (MFA) platform based at least in part on the resource associated with the access request and on user information registered with the enterprise;
initiating, by the authenticator, operation of the selected MFA platform; and
verifying, by the authenticator, an identity of the user via the selected MFA platform.

19. The method of claim 18, further comprising:
assessing a first security risk level associated with the user, the first security risk level based at least part on user information registered with the enterprise;
assessing a second security risk level associated with the resource of the enterprise, the second security risk level based at least part on the resource associated with the access request; and
selecting the MFA platform based at least in part on the first and second assessed security risk levels.

20. The method of claim 19, wherein the MFA platform is a first MFA platform, and the method further comprises selecting, by the authenticator, a second MFA platform based at least in part on the first and second assessed security risk levels, wherein the second MFA platform is different than the first MFA platform.
